(19) United States
(12) Patent Application Publication
(10) Pub. No.: US 2006/0146390 A1
(43) Pub. Date: Jul. 6, 2006

(54) Optical isolator

(75) Inventors: Tsung-Kai Chuang, Tainan City (TW); Mei-Leng Choi, Tainan City (TW); Jiann-Hua Wang, Taipei (TW)

Correspondence Address: BIRCH STEWART KOLASCH & BIRCH, PO BOX 747, FALLS CHURCH, VA, 22040-0747, US

(73) Assignee: Kaiwood Technology Co., Ltd.

(21) Appl. No.: 11/156,470

(22) Filed: Jun. 21, 2005

(30) Foreign Application Priority Data
Dec. 30, 2004 (TW) 093141369

(51) Int. Cl. G02F 1/09

(52) U.S. Cl. 359/280

(57) ABSTRACT

A core device of optical isolator comprises a polarizer and a polarization-rotating device, which are integrated together as a modularized device. The modularized core device can be combined with other optical components to provide optical isolators of desired characteristics. With the modularized core device, the assembling of optical isolator is simplified and combination with other component is enhanced, thereby extending the applications of the core device.

### BACKGROUND OF THE INVENTION

1. Field of the Invention

The present invention relates to an optical isolator, and in particular to a modularized core device of the optical isolator, featuring easy assembling and combination with other optical components to provide optical isolators satisfying different requirements.

2. The Prior Arts

Because of advantages of small loss of signals, high capacity, high transmission speed, free from EMI, high security, little mass, and small volume, optical communication has been one of the most prosperous sectors of communication industry since 1970s. Thanks to the invention of optical fiber and the development of semiconductor laser, the optical communication gradually plays an important role in all fields of communication business, including long-distance sea cables, local area phone trunks, computer data networks, and optical fibers for CATV/coaxial cable hybridized wiring network. The application of the optical communication is extended from inter-country communication to communication between families and people.

The optical communication generally comprises active components arranged at transmitter end and receiver end and also requires passive components arranged between the transmitter end and the receiver end to maintain and enhance quality of optical signal in transmission. In general, the passive component is not provided with any external energy source to thereby change any original optical signal. In other words, the passive component is a component that is not involved in conversion between electrical energy and optical energy and that only performs non-power-related operations, such as splicing, branching, filtering, isolating, and attenuating of optical signals by its own optical characteristics.

A number of optical passive components are known, among which an optical isolator is a matured product in fabrication technology. The optical isolator is largely applied to optical transmitters and amplifiers for reducing noise in high-speed transmission by minimizing the attenuation of a light beam in a forward transmitting direction and blocking that in reversed transmission. In some optical transmission systems, the optical isolator is used to limit optical signal to transmit in a single direction. For example, the optical isolator is employed to protect a laser source for interference with by light beam in opposite direction. Or the optical isolator is used to reduce amplified spontaneous emission and noises in optical amplifiers.

The optical isolator is a powerless device, which, based on non-interchangeable characteristic of Faraday rotator, allows only one-way transmission of light. The Faraday effect imposes rotary polarization in a transparent substance that is not optically active, such as water and lead glass, by positioning the substance in a strong magnetic field. The effect may be exemplified by putting a magneto-optical medium in a magnetic field such that when light parallel with the magnetic field prorogate through the medium, polarization direction of an incident plane polarized light is rotated a transfer angle of which the size is dependent upon the properties of the medium, travel of light, as well as the magnitude of the magnetic field.

As shown in FIG. 1 of the attached drawings, the optical isolator comprises an input port, a first polarizer 1, a Faraday rotator 2, a second polarizer 3, and an output port. The first polarizer 1, the Faraday rotator 2, and the second polarizer 3 together constitute a core of the optical isolator. Both the first and the second polarizers 1, 3 induce polarization of the incident light. The polarizers are generally arranged at an angle of 45 degrees between optical axes thereof. The Faraday rotator 2 serves to rotate the polarization plane of the polarized incident light. A commonly employed rotating angle of the Faraday rotator 2 is 45 degrees.

When an optical signal is incident upon the first polarizer 1 through the input port, the incident light is polarized to enter the Faraday rotator at 45 degrees and the polarization plane of the polarized light is rotated 45 degrees. Since the intersection angle between the optical axis of the second and the first polarizer are 45 degrees, the polarized light passing through the Faraday rotator is allowed to pass through the second polarizer 3 and emitted from the output port.

When light traveling in opposite direction, such as reflected light, hits onto the second polarizer 3, the light is polarized by the second polarizer and the polarization plane of the light is rotated 45 degrees. Since the light travels in the reversed direction, the polarized light goes on to transmit through the Faraday rotator 2, which further rotates the polarization plane for another 45 degrees, making the polarization plane of the incident light at an angle of 90 degrees with respect to the first polarizer 1. Thus, the light will be completely blocked by the first polarizer 1 and thus realizing one-way transmission of optical signals.

Although the optical isolator allows for realization of unidirectional transmission of light, yet the optical isolator causes change of length of optical path along which the optical signals travels through the optical isolator. This often results in chaos of identification of optical signals. Solution for such a problem by modifying component constituting the core of the optical isolator is available, such as that disclosed in Taiwan Patent No. 237522, which uses a large number of polarizers and rotors to reduce loss of optical signals. However, the increased number of components for the isolator core complicates the assembly process of isolator for increased workload for high precision calibration and alignment of the components is required.

Further, the core components of the optical isolator are seemingly aggregated in a fixed module. This makes the conventional isolator not ready to satisfy different requirements for different applications.

### SUMMARY OF THE INVENTION

The present invention is aimed to provide an optical isolator, which dissolves the above-mentioned problems, simplifies the assembling process of optical isolators, and allows for arbitrary combination of an optical isolator with other optical component to thereby expanding the applications of the optical isolator.

An objective of the present invention is to provide a core device of the optical isolator, comprising a polarizer and a polarization-rotating device, which are integrated together as a modularized device. The core device is further provided with an optical input port by end of the polarizer, and an optical output port by end of the polarization-rotating device.

Another objective of the present invention is to provide an optical isolator comprising a core device, which may be combined with other optical components elements to provide desired characteristics of the optical isolators.

The core device of optical isolator in accordance with the present invention comprises a polarizer and a polarization-rotating device. The polarizer is made of commonly used birefringent crystal, such as rutile, calcite, lithium niobate (LiNbO₃), and yttrium vanadate (YVO₄). The polarization-rotating device is made of commonly used magneto-optical crystal, such as paramagnetic glass and yttrium iron garnet (YIG). Also, the polarizer and the polarization-rotating device can be of any desired thickness, which allows the polarizer and the polarization-rotating device to be made with different characteristics of polarization and optical activity.

In practice, a number of the core devices in accordance with the present invention can be selectively jointed or combined with other optical devices, such as polarizers and polarization-rotating devices of different types, to form optical isolators of desired characteristics. The core device of the present invention is a modularized device, which allows the device to be calibrated for any desired angle and gives the device flexibility in different applications. In addition, the core device of the present invention has a simple structure, which simplifies the manufacturing process and reduces defect rate of product.

For more detailed information regarding advantages or features of the present invention, a preferred embodiment of the present invention will be described with reference to the annexed drawings, in which:

### BRIEF DESCRIPTION OF THE DRAWINGS

FIG. 1 is a schematic view showing a conventional optical isolator;

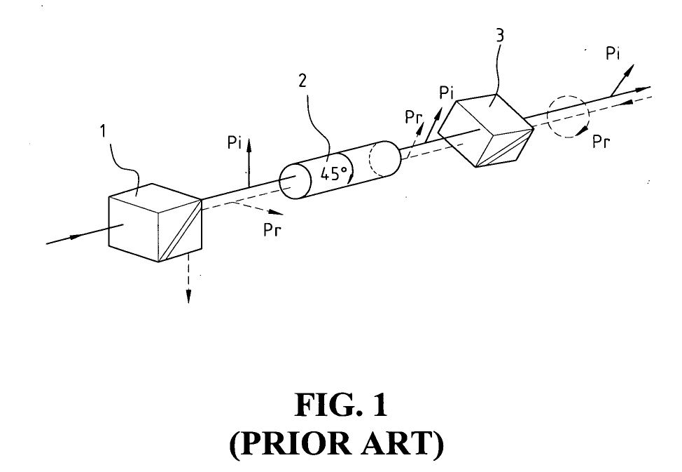

FIG. 2 is a schematic side elevational view of a core device constructed in accordance with the present invention;

FIG. 3 is a schematic view showing an optical isolator incorporating the core device of the present invention; and

FIG. 4 is a schematic view showing another optical isolator incorporating the core device of the present invention.

### DETAILED DESCRIPTION OF THE PREFERRED EMBODIMENT

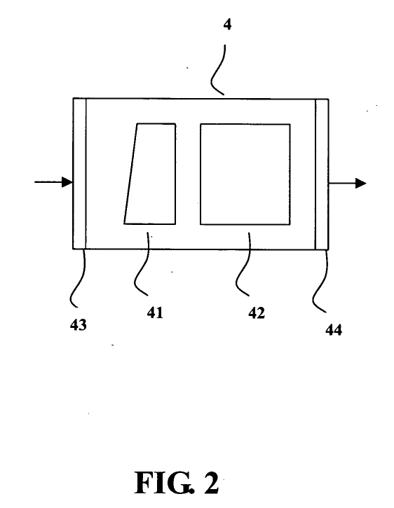

With reference to the drawings and in particular to FIG. 2, a core device constructed in accordance with the present invention, generally designated with reference numeral 4, comprises a polarizer 41 and a polarization-rotating device 42. In accordance with the present invention, the polarizer 41 and the polarization-rotating device 42 are integrated together as a modularized device. The core device 4 also comprises an optical input port 43 and an optical output port 44 at opposite ends of the device 4 and adjacent to the polarizer 41 and the polarization-rotating device 42, respectively.

It is noted that the arrows in FIG. 2, as well as other drawings attached herein, represent the traveling direction of light.

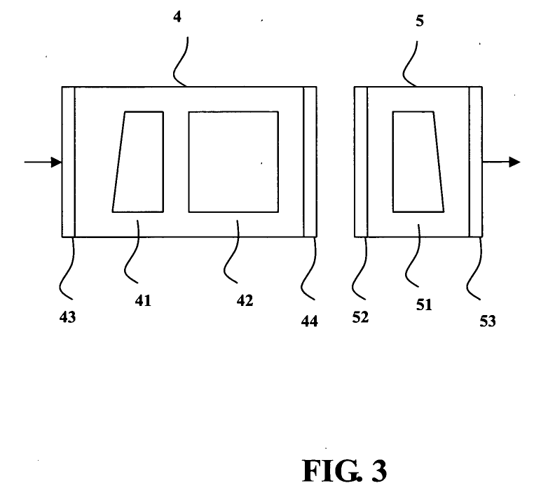

Also referring to FIG. 3, which shows an optical isolator incorporating the core device 4 of the present invention, the optical isolator comprises an optical component 5 jointed to the core device 4 to form a “fundamental” optical isolator. The optical component 5 comprises for example a polarizer 51 and input and output ports 52, 53 on opposite ends of the polarizer 51. The fundamental optical isolator is formed by jointing or coupling the optical output port 44 of the core device 4 to the optical input port 52 of the optical component 5. With such a combination, an input fiber optic is connected to the optical input port 43 of the core device 4 and an output fiber optic is connected to the optical output port 53 of the optical component 5 for transmission of optical signals through the combined device.

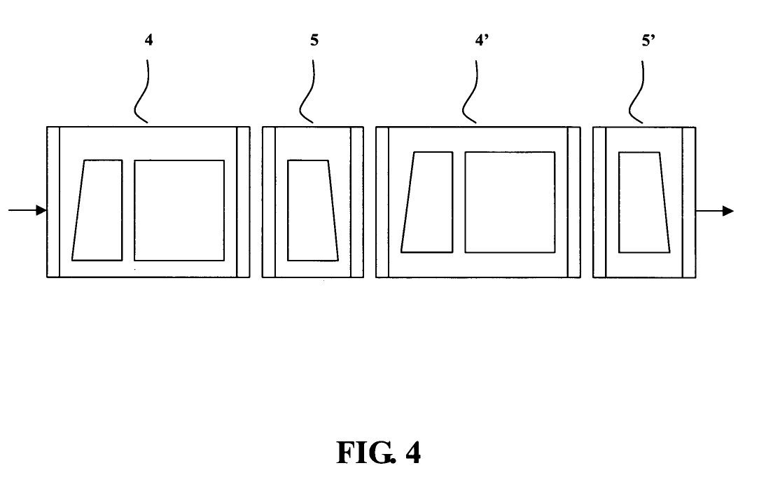

Also referring to FIG. 4, which shows another optical isolator incorporating the core device 4 of the present invention, the optical isolator of FIG. 4 comprises a plurality of core devices 4 and other optical components 5 coupled together in a cascade form. This arrangement provides optical isolators of different desired characteristics for the core devices may be of different specifications and the optical components 5 can be selected from a number of known optical devices with different optical characteristics.

Furthermore, in the present invention, which comprises further a glass tube, wherein the core device is wrapped in the glass tube but not the conventional metal tube. And it also has the advantage that if the optical component 5 is jointed to the core device 4 first, then it will only need to make the alignment of X, Y, Z axes and does not have to make the adjustment of angle. After the alignment, epoxy is applied at high temperature for joint and no post curing is required. The core device for optical isolator according to the present invention has a much lower TDL (Temperature Dependent Loss) and no post bending is required. The volume of the core device according to the present invention can be as small as a tube of 20 mm in length and 4 mm in diameter.

Although a preferred embodiment of the present invention, as well as applications thereof, has been described in detail with reference to the drawings annexed, it is apparent to those having ordinary skills in the art that numerous changes or modifications may be made without departing from the true spirit and scope thereof, as set forth in the claims below.

What is claimed is:

1. A core device adapted to constitute an optical isolator, comprising a polarizer and a polarization-rotating device, which are integrated together as a modularized device.

2. The core device as claimed in claim 1 further comprising an optical input port and an optical output port.

3. The core device as claimed in claim 1, wherein the polarizer comprises birefringent crystal.

4. The core device as claimed in claim 3, wherein the birefringent crystal is selected from a group consisting of rutile, calcite, lithium niobate (LiNbO₃), and yttrium vanadate (YVO₄).

5. The core device as claimed in claim 1, wherein the polarization-rotating device comprises a Faraday rotator.

6. The core device as claimed in claim 1, wherein the polarization-rotating device comprises magneto-optical crystal.

7. The core device as claimed in claim 6, wherein the magneto-optical crystal comprises paramagnetic glass.

8. The core device as claimed in claim 6, wherein the magneto-optical crystal comprises yttrium iron garnet (YIG).

9. The core device as claimed in claim 1, which comprises further a glass tube, wherein the core device is wrapped in the glass tube.

10. The core device as claimed in claim 1, wherein the core device is a tube of 20 mm in length and 4 mm in diameter.

11. An optical isolator, comprising a core device, which comprises a polarizer and a polarization-rotating device, which are integrated together as a modularized device.

12. The optical isolator as claimed in claim 11, wherein the core device further comprises an optical input port and an optical output port.

13. The optical isolator as claimed in claim 11, wherein the polarizer comprises birefringent crystal.

14. The optical isolator as claimed in claim 13, wherein the birefringent crystal is selected from a group consisting of rutile, calcite, lithium niobate (LiNbO3), and yttrium vanadate (YVO4).

15. The optical isolator as claimed in claim 11, wherein the polarization-rotating device comprises a Faraday rotator.

16. The optical isolator as claimed in claim 11, wherein the polarization-rotating device comprises magneto-optical crystal.

17. The optical isolator as claimed in claim 16, wherein the magneto-optical crystal comprises paramagnetic glass.

18. The optical isolator as claimed in claim 16, wherein the magneto-optical crystal comprises yttrium iron garnet (YIG).

19. The optical isolator as claimed in claim 11, which comprises further a glass tube, wherein the core device is wrapped in the glass tube.

20. The optical isolator as claimed in claim 11, wherein the core device is a tube of 20 mm in length and 4 mm in diameter.
